(19) United States
(12) Patent Application Publication
(10) Pub. No.: US 2015/0373431 A1
(43) Pub. Date: Dec. 24, 2015

(54) Split Spectrum Spectral Domain Optical Coherence Tomography

(71) Applicant: CANON KABUSHIKI KAISHA, Tokyo (JP)

(72) Inventor: Takefumi Ota, Tucson, AZ (US)

(21) Appl. No.: 14/312,281

(22) Filed: Jun. 23, 2014

(51) Int. Cl. H04Q 11/00

(52) U.S. Cl. CPC H04Q 11/0005; H04Q 2011/0037; H04Q 2011/0035; H04Q 2011/0026

(57) ABSTRACT

A spectral domain optical coherence tomography apparatus for measuring a sample. The spectral domain optical coherence tomography includes a broadband light source, that supplies broadband light to the sample and a reference. The spectral domain optical coherence tomography apparatus includes a wavelength selective switch that receives mixed light that is a combination of the broadband light that is reflected off the sample and the reference. The spectral domain optical coherence tomography apparatus includes a sensor that includes a plurality of pixels. The wavelength selective switch guides a first portion of the mixed light that is within a first wavelength and a second wavelength to the sensor during a first period of time. The wavelength selective switch guides a second portion of the mixed light that is within a third wavelength and a fourth wavelength to the sensor during a second period of time.

### BACKGROUND

1. Field of Art

The present disclosure is directed towards systems and methods used in spectral domain optical coherence tomography (SD-OCT)

2. Description of the Related Art

Optical coherence tomography (OCT) is a powerful instrument for imaging objects including biological tissues. Two different types of OCTs are spectral domain OCT (SD-OCT) and a swept source OCT (SS-OCT). A SD-OCT includes a light source with wide spectral range, an interferometer, and a spectrometer. A SS-OCT includes a wavelength scanning light source, an interferometer and a balanced detector.

In the SS-OCT, a wavelength of the light source is temporally changed from a shorter wavelength to a longer wavelength or from a longer wavelength to a shorter wavelength. In order to achieve deep scanning depth, a high resolution, and a high speed scanning; the line width of the light source should be narrow, a total wavelength range should be wide, and wavelength sweeping rate should be fast. The light source may be a pulsed source.

The spectrometer of the SD-OCT may use line sensors to detect the wavelength dependence of the interferogram. The SD-OCT may use 2 line sensors to implement a balanced detector SD-OCT (BD-SD-OCT).

The scanning depth resolution of a OCT is directly related to a coherence length of the light source. Assuming that the spectral shape of the light source is Gaussian, the coherence length is determined by equation (1) below.

$$2 Δ z = {l}_{c} = \frac{4 ln 2}{π} \cdot \frac{{λ}_{c}^{2}}{Δλ} \qquad ( 1 )$$

l_{c}: Coherence length of the light source.

λ_{c}: Center wavelength of the light source.

Δλ: Spectrum full width at half maximum (FWHM) of the light source.

Δz: scanning depth.

The scanning depth resolution of the OCT may be determined by equation (1) when the full spectral width of the source is obtained by the detector and the pixel density of the detector is sufficient to characterize the wavelength dependence of the interferogram. The detector can thus be a limiting factor. A typical detector for an SD-OCT is a linear image sensor. When using a linear image sensor a compromise is made between the number of pixels, pixel size, and noise. When a very broadband source is used, a sensor array with a large number of pixels must be used which tends to reduces the size of the pixels, increase the noise, and increase the cost.

What is needed is a means for allowing sensor arrays with fewer pixels to be used to characterize the wavelength dependence of the interferogram when a very broadband source is used.

### SUMMARY

A spectral domain optical coherence tomography apparatus for measuring a sample. The spectral domain optical coherence tomography receives a broadband light source, that supplies broadband light to the sample and a reference. The spectral domain optical coherence tomography apparatus includes a wavelength selective switch that receives mixed light that is a combination of the broadband light that is reflected off the sample and the reference. The spectral domain optical coherence tomography apparatus includes a sensor that includes a plurality of pixels. The wavelength selective switch guides a first portion of the mixed light that is within a first wavelength and a second wavelength to the sensor during a first period of time. The wavelength selective switch guides a second portion of the mixed light that is within a third wavelength and a fourth wavelength to the sensor during a second period of time.

In an embodiment, the first period of time and the second period of time do not overlap.

In an embodiment, the first wavelength is less than the second wavelength, the third wavelength is less than the fourth wavelength, the third wavelength is less than the second wavelength.

In an embodiment, the wavelength selective switch comprises: a first diffraction grating with a first grating pitch; a second diffraction grating with the first grating pitch; a first movable mirror with a first rotation axis; and a second movable mirror with a second rotation axis that is parallel to the first rotation axis. The first diffraction grating is arranged parallel to the second diffraction grating. The first movable mirror is adjusted to a first angle relative to a first line connecting the first rotation axis and the second rotation axis. The second movable mirror is adjusted to the first angle relative to the first line, such that wavelength selective switch guides the first portion of the mixed light to the sensor during the first period of time. The first and second movable mirrors are adjusted to a second angle relative to the first line, such that wavelength selective switch guides the second portion of the mixed light to the sensor during the second period of time.

In an embodiment, the spectral domain optical coherence tomography apparatus includes a broadband light source.

In an embodiment, the wavelength selective switch comprises: a first dispersive optical component which spatially disperse light; a second dispersive optical component which spatially disperse light; a first movable mirror with a first rotation axis; and a second movable mirror with a second rotation axis that is parallel to the first rotation axis. The first dispersive optical component is arranged relative to the second dispersive optical component such that different wavelengths of the mixed light are spatially dispersed and substantially collinear. The first movable mirror is adjusted to a first angle relative to a first line connecting the first rotation axis and the second rotation axis. The second movable mirror is adjusted to the first angle relative to the first line, such that wavelength selective switch guides the first portion of the mixed light to the sensor during the first period of time. The first and second movable mirrors are adjusted to a second angle relative to the first line, such that wavelength selective switch guides the second portion of the mixed light to the sensor during the second period of time.

In an embodiment, the spectral domain optical coherence tomography apparatus for measuring a sample comprising: receiving a broadband light source, that supplies broadband light to the sample and a reference; an optical coupler that receives broadband light reflected off the sample and broadband optical light reflected off the references and produced a first mixed light and a second mixed light; a first wavelength selective switch that receives the first mixed light; a first sensor that includes a plurality of pixels; a second wavelength selective switch that receives second mixed light; and a second sensor that includes a plurality of pixels. The first wavelength selective switch guides a first portion of the first mixed light that is within a first wavelength and a second wavelength to the first sensor during a first period of time. The first wavelength selective switch guides a second portion of the first mixed light that is within a third wavelength and a fourth wavelength to the first sensor during a second period of time. The second wavelength selective switch guides the first portion of the second mixed light that is within the first wavelength and the second wavelength to the second sensor during the first period of time. The second wavelength selective switch guides the second portion of the second mixed light that is within the third wavelength and the fourth wavelength to the second sensor during the second period of time.

Further features and aspects will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments.

FIG. 1 is an illustration of an optical coherence tomography apparatus.

FIGS. 2A-B are illustrations of the optical spectra of optical sources that may be used in an optical coherence tomography apparatus.

FIGS. 4A-C are illustrations of a wavelength selective optical switch that may be used in an optical coherence tomography apparatus.

FIG. 5 is an illustration of the angle of the mirrors in the wavelength of the selective switch.

FIG. 6 is an illustration of optical source that includes a switch that may be used in an optical coherence tomography.

### DESCRIPTION OF THE EMBODIMENTS

Embodiments will be described below with reference to the attached drawings.

The present disclosure is described in the context of a BD-SD-OCT but is applicable to an OCT with a different architecture.

### First Exemplary Embodiment

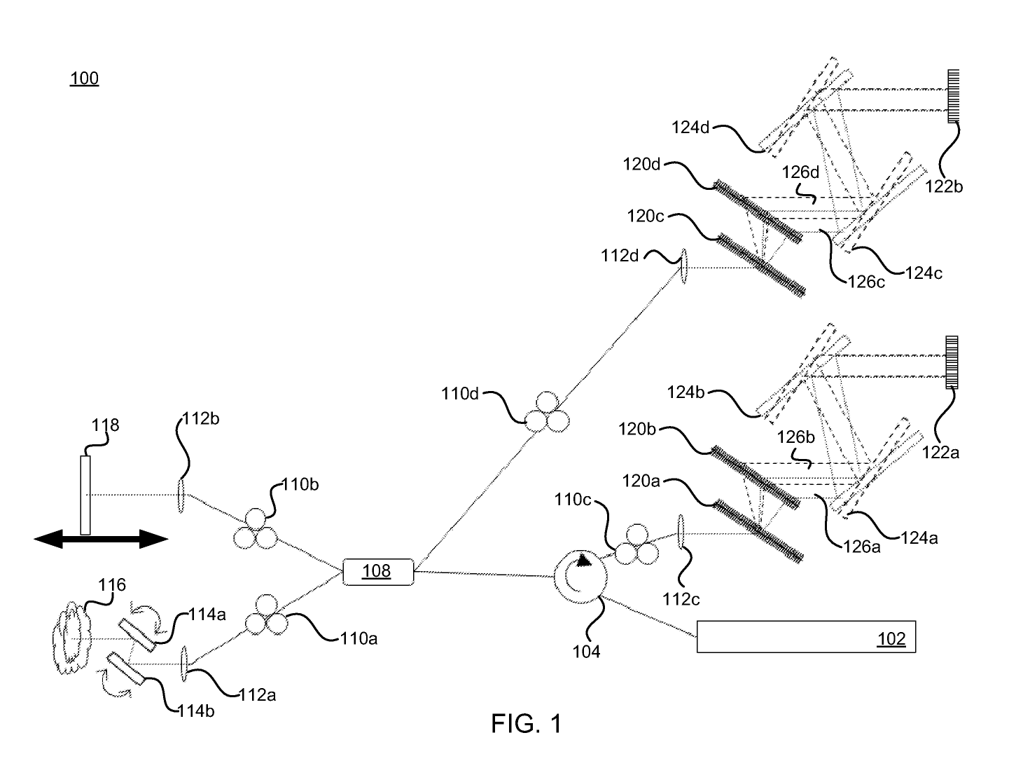

A first exemplary embodiment 100 of a split spectrum OCT is a BD-SD-OCT 100 illustrated in FIG. 1. The BD-SD-OCT 100 uses optical fibers components, however free space optics may be used instead for one or more of the optical fibers components. The BD-SD-OCT 100 is an imaging apparatus 100. Apparatus 100 uses a broadband light source 102 with a bandwidth of 100 nm, 200 nm, 500 nm 1000 nm or 2000 nm. The broadband light source 102 may be based on semiconductor, fiber optics, lamps, and/or solid state crystals. An example of the broadband light source 102 is a super luminescent diode.

The broadband light source 102 is coupled to a first port of a circulator 104. Both the circulator 104 and the broadband light source 102 may be fiber coupled or free space components. An isolator 106 (not shown) may be inserted between the circulator 104 and the broadband light source 102. The isolator 106 may improve the RIN noise of the broadband light source 102. Light from the first port of the circulator 104 couples the light to the second port of the circulator 104.

Light from the second port of the circulator 104 is coupled into a first port of the fused fiber optical coupler 108. Light from the first port of the fused fiber coupler 108 is divided into two beams of light and is coupled to a second port and a third port of the fused fiber coupler 108. Light from the second port of the fused fiber coupler 108 is passed through a first polarization controller 110a and exits a first lens 112a as a measurement beam. Light from the third port of the fused fiber coupler 108 is passed through a second polarization controller 110b and exits a second lens 112b as a reference beam.

The measurement beam exiting the first lens 112a is then scanned by a first scanner 114a and a second scanner 114b across a measurement target 116. The first scanner 114a and the second scanner 114b can be combined into a single scanner. The scattered and reflected light from the measurement target 116 passes back through the first scanner 114a, the second scanner 114b, first lens 112a, a first polarization controller 110a and back into the second port of the fused fiber coupler 108. In an alternative embodiment, the scanners 114a-b are removed or kept still and the measurement target 116 is moved instead. In another alternative embodiment, both the scanners 114a-b and the measurement target 116 are moved.

The reference beam exiting the second lens 112b is reflected off a reference mirror 118. The reference mirror 118 may be translated along the optical axis of the second lens 112b during the measurement process. The light reflected off the reference mirror 118 passes back through the second lens 112b, polarization controller 110b and back into the third port of the fused fiber coupler 108.

The fused fiber coupler 108 mixes the light that enters from the second port and the third port of the fused fiber coupler 108 and couples the mixed interference light into both the first port of the fused fiber coupler 108 and a fourth port of the fused fiber coupler 108.

Light that exits the first port of the fused fiber coupler 108 is coupled into the second port of the circulator 104. Light that exits the second port of the circulator 104 is then coupled out of a third port of the circulator 104 and passes through a third polarization controller 110c and a third lens 112c. Light exiting the third lens 112c is incident on a first diffraction grating 120a. The first diffraction grating 120a diffracts the light which is then diffracted again by second diffraction grating 120b. The first and second diffraction gratings 120a-b may be arranged such that the light exiting the second diffraction grating is spatially dispersed relative to the wavelength of light, while being collinear. This may be accomplished with diffraction gratings 120a-b that are substantially parallel to each other. The diffraction gratings 120a-b shown in FIG. 1 are transmission gratings but may be reflection gratings.

As illustrated in FIG. 1, the lens 112c produces a collimated beam which is incident upon the first diffraction grating 120a. The first diffraction grating 120a disperses incident light such that the angle of the light exiting the first diffraction grating 120a is a function of the wavelength of light. This produces a fan shaped beam of light which is illustrated in FIG. 1. FIG. 1 shows this fan shaped beam of light can be divided into two logical portions a first portion 126a that is shown with light gray dotted lines and a second portion 126b that is shown with dark gray dashed lines. The first portion 126a represents light between wavelengths λ₁ and λ₂. The second portion 126b represents light between wavelengths λ₃ and λ₄. The fan shaped part of the first portion 120a may partially overlap with a second portion 120b. The fan shaped part of the first portion 120a may be adjacent to the second portion 120b.

The second diffraction grating 120b is substantially parallel to the first diffraction grating 120a such that when the diffracted light is incident on the second diffraction grating 120b it exits as a collinear beam such that angle between light with different wavelengths is substantially small or zero, yet the spatial position of the light with different wavelengths is the same. As shown in FIG. 1 the portions 120a-b are portions of a parallel beam that are adjacent or partially overlap.

The light exiting the diffraction grating is incident upon a first movable mirror 124a which is reflected onto a second movable mirror 124b, which is then reflected onto a first linear detector array. The first and second movable mirrors 124a-b act together to form a first optical switch which together with the diffraction gratings changes the wavelength band that is incident upon a first linear sensor array 122a. The second mirror 124b may be a different size or the same size as the first mirror 124a.

Light that exits the fourth port of the fused fiber coupler 108 passes through a fourth polarization controller 110d and a fourth lens 112d. Light exiting the fourth lens 112d is incident on a third diffraction grating 120c. The third diffraction grating 120c diffracts the light which is then diffracted again by fourth diffraction grating 120d. The third and fourth diffraction gratings 120c-d may be arranged such that the light exiting the second diffraction grating is spatially dispersed relative to the wavelength of light, while being collinear. This may be accomplished with diffraction gratings 120c-d that are substantially parallel to each other. The diffraction gratings 120c-d shown in FIG. 1 are transmission gratings but may be reflection gratings.

As illustrated in FIG. 1, the lens 112d produces a collimated beam which is incident upon the third diffraction grating 120c. The third diffraction grating 120c disperses incident light such that the angle of the light exiting the first diffraction grating 120c is a function of the wavelength of light. This produces a fan shaped beam of light which is illustrated in FIG. 1. FIG. 1 shows this fan shaped beam of light can be divided into two logical portions a third portion 126c that is shown with light gray dotted lines and a fourth portion 126d that is shown with dark gray dashed lines. The third portion 126c represents light between wavelengths λ₁ and λ₂. The fourth portion 126d represents light between wavelengths λ₃ and λ₄. The fan shaped part of the third portion 120c may partially overlap with a fourth portion 120d. The fan shaped part of the third portion 120c may be adjacent to the fourth portion 120d.

The fourth diffraction grating 120d is substantially parallel to the third diffraction grating 120c such that when the diffracted light is incident on the third diffraction grating 120c it exits as a collinear beam such that angle between light with different wavelengths is substantially small or zero, yet the spatial position of the light with different wavelengths is the same. As shown in FIG. 1 the portions 120c-d are portions of a parallel beam that are adjacent or partially overlap.

The light exiting the fourth diffraction grating is incident upon a third movable mirror 124c which is reflected onto a fourth movable mirror 124d, which is then reflected onto a second linear detector array. The third and fourth movable mirrors 124c-d act together to form a second optical switch which together with the diffraction gratings changes the wavelength band that is incident upon a second linear sensor array 122b.

The fused fiber optical coupler 108 and/or the polarization controllers 110a-d may be replaced with free space optical components. The optical coupler 108 splits light received into an optical and outputs light out of two optical ports. The optical coupler 108 also mixes light received into two optical ports and outputs mixed light out of one or two optical ports. The lenses 112a-d may be fiber coupled GRIN lenses which substantially collimate the light exiting the lenses. The diffraction gratings 120a-b may be transmission gratings or reflection gratings. The detectors 122a-b may be linear detectors arrays or 2-D detector array that are operated as a 1-D detector array. A slit or aperture may be placed between the diffraction gratings and the detectors. The diffraction gratings may also be 120a-b other optical components which spatially disperse light such as a prism. Two or more of the free space optical components which have substantially similar properties may be replaced with a single optical component and one or more mirrors that fold that optical path such that light passes through the optical component multiple times. The polarization controllers may be removed and the optical components may be chosen such that the polarization that is controlled by the choice and arrangement of the optical components.

The OCT may also be modified to include an additional circulator along the reference arm of OCT. The OCT may also be modified to include a single linear array and a single detection arm instead of two linear arrays and two detection arms. The light source 102 may also be replaced with multiple light sources.

### First Numerical Exemplary Embodiment

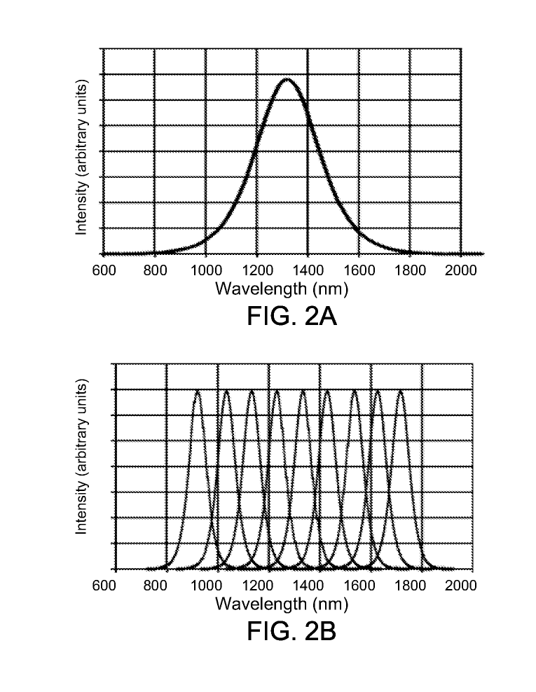

The following is a specific example of the first exemplary embodiment. The light source 102 is super-continuum (SC) light source. Total output spectrum of this SC light source 102 is 0.8-1.8 μm shown as illustrated in FIG. 2A. The center wavelength λ_{c} is 1.3. The FWHM Δλ is 0.5 μm. Repetition rate of the light source is 50 MHz. The average total power of the light source is 10 mW. The pitch of gratings 120a-d is 900 line/mm. The angle between the incident beam from the lenses 112c and the plane of the first and third gratings is 47°. The lines sensors 122a-b each have 4096 pixels. The size of each pixel is 10 μm. The total length of each of the line sensors 122a-b is approximately 41 mm. The scan rate of the line sensor is 140 kHz. Based upon equation (1) the maximum depth resolution should be about 1.7 μm.

A goal of this OCT is to have a scanning depth of greater than 25 mm. To accomplish this goal each pixel should be arranged relative to the dispersive elements to obtain a FWHM of spectral resolution at each pixel to be less than 0.015 nm. When each of the line sensors 122a-b have 4096 pixels then total spectral width detected by each sensor is about 122 nm. The sensors 122a-b can be used 9 times to detect 9 different bands across the entire spectrum of the light source 102, which may be approximated as 2Δλ which in this case is 1000 nm. The scan rate of the line sensors 122a-b is 140 kHz so the total scanning rate is be about 15.5 kHz.

Given a grating pitch of 900 line/mm and an incident beam angle of 47°, the radiated angle from the first diffraction grating 122a is 5.2° for 0.8 um and is 82.2° for 1.8 um. The distance between the first diffraction grating 122a and the second grating 122b may be set at 75.5 mm, which sets the ultimate resolution of each pixel. The distance between the third diffraction grating 122c and the third diffraction grating 122d is the same as the distance between the first diffraction grating 122a and the second grating 122b.

### Optical Switch

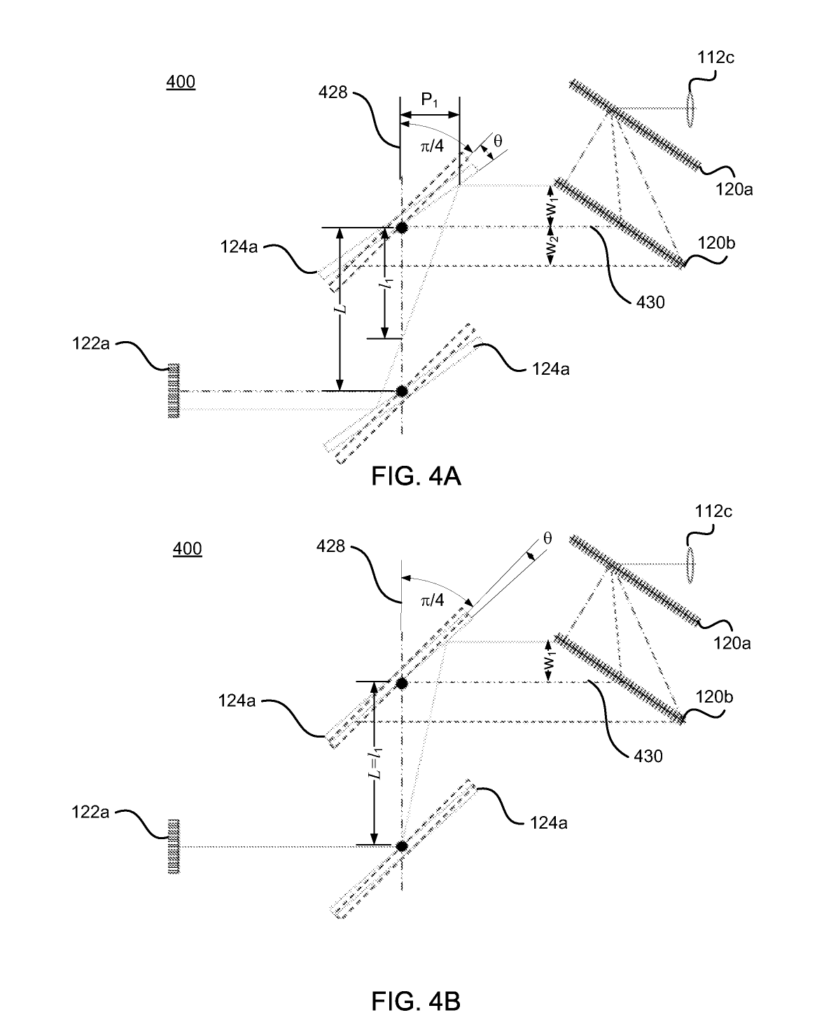

FIGS. 4A-C are illustrations of the relationship between the components that make up an optical switching system 400. The optical switch 400 includes the third lens 112c, the first diffraction grating 120a, a second diffraction grating 120b, a first movable mirror 124a, a second movable mirror 124b, and a first detector 122a. The following equations are used to characterize the behavior of the optical switch 400.

$$\begin{matrix}{P}_{1} ( θ ) = {w}_{1} \cdot tan ( \frac{π}{4} + θ ) & ( 2 ) \\ {l}_{1} ( θ ) = {P}_{1} ( θ ) \cdot tan ( \frac{π}{2} - 2 θ ) - {w}_{1} & ( 3 )\end{matrix}$$

P₁: is a first distance from a first center vertical line 428 to a first reflection point which is on the first mirror 124a.

w₁: is a first width from the center 430 of an optical path between a second diffraction grating 120b and the first movable mirror 124a of an optical path and is representative of a first target wavelength λₜ₁.

θ: is the angle minus

$$\frac{π}{4}$$

of the first movable mirror 124a relative first center vertical line 428.

Equation (3) characterizes a part of the distance that an off center light ray travels after being reflected by the first mirror 124a.

$${l}_{1} ( θ ) = {P}_{1} ( θ ) \cdot tan ( \frac{π}{2} - 2 θ ) - {w}_{1} \qquad ( 3 )$$

l₁: is a distance from a rotation center point (axis) of the first mirror 124a to an intersection point of light ray reflected from the first reflection point and the first center vertical line 428.

Equations (2) and (3) can be combined to obtain equation (4).

$${l}_{1} ( θ ) = {w}_{1} \cdot ( tan ( \frac{π}{4} + θ ) \cdot tan ( \frac{π}{2} - 2 θ ) - 1 ) \qquad ( 4 )$$

In an optimal design of the system 100 the first target wavelength λₜ₁ should hit a center of the line sensor 122a which means that equations (5) and (6) should be satisfied.

$$\begin{matrix}L = {l}_{1} ( θ ) & ( 5 ) \\ θ = {tan}^{- 1} ( 2 \frac{L}{{w}_{1}} - \sqrt{{( 2 \frac{L}{{w}_{1}} )}^{2} - 1} ) & ( 6 )\end{matrix}$$

L: is a distance between the rotation point (axis) of the first mirror 124a and a rotation point of the second mirror 124b. The rotation axes of the first and second mirrors 124a-b may be offset from the center of mirrors 124a-b. The rotation axes of the first and second mirrors 124a-b are parallel to each other. The rotation axes of the first and second mirrors 124a-b may be parallel to the planes of the first and second diffraction gratings 120a-b. The rotation axes of the first and second mirrors 124a-b may be tilted to the planes of the first and second diffraction gratings 120a-b.

Equation (6) characterizes the angle θ that the first mirror should be adjusted to based upon a distance of the first target wavelength λₜ₁ to the center line 430 relative to the distance between two mirrors L. FIG. 4B is an illustration in which 0 was set to the appropriate angle to ensure that the first target wavelength λₜ₁ associated with the distance w₁ from the center line 430.

FIGS. 4A-B illustrate how the movable mirrors 124a-b are adjusted relative to a setting the moveable mirrors in a first direction relative to a 45 degree point relative to first center vertical line 428. FIG. 4C is an illustration of how the movable mirrors 124a-b are adjusted relative to a setting the moveable mirrors in a second direction opposite to the first direction relative to a 45 degree point relative to first center vertical line 428.

$${P}_{2} ( {θ}^{′} ) = {w}_{2} \cdot tan ( \frac{π}{4} - {θ}^{′} ) \qquad ( 7 )$$

P₂: is a second distance from the first center vertical line 428 to a second reflection point which is on the first mirror 124a.

w₂: is a second width from the center 430 of an optical path between a second diffraction grating 120b and the first movable mirror 124a and the optical path is representative of a second target wavelength λₜ₂.

θ′: is

$$\frac{π}{4}$$

minus the angle of the first movable mirror 124a relative first center vertical line 428.

Equation (8) characterizes a part of the distance that an off center light ray travels after being reflected by the first mirror 124a.

$${l}_{2} ( {θ}^{′} ) = {P}_{2} ( {θ}^{′} ) \cdot tan ( \frac{π}{2} - 2 {θ}^{′} ) + {w}_{2} \qquad ( 8 )$$

l₂: is a distance from a rotation center point of the first mirror 124a to an intersection point of light ray reflected from the first reflection point and the first center vertical line 428.

Equations (7) and (8) can be combined to obtain equation (9).

$${l}_{2} ( {θ}^{′} ) = {w}_{2} \cdot ( tan ( \frac{π}{4} - {θ}^{′} ) \cdot tan ( \frac{π}{2} - 2 {θ}^{′} ) + 1 ) \qquad ( 9 )$$

In an optimal design of the system 100 the second target wavelength λₜ₂ should hit a center of the line sensor 122a which means that equations (10) and (11) should be satisfied.

$$\begin{matrix}L = {l}_{2} ( {θ}^{′} ) & ( 10 ) \\ {θ}^{′} = {tan}^{- 1} ( \sqrt{{( 2 \frac{L}{{w}_{2}} )}^{2} - 1} - 2 \frac{L}{{w}_{2}} ) & ( 11 )\end{matrix}$$

Equation (11) characterizes the angle θ′ that the first and second mirrors should be adjusted to based upon a distance of the second target wavelength λₜ₂ to the center line 430 relative to the distance between two mirrors L. FIG. 4B is an illustration in which θ′ was set to the appropriate angle to ensure that the target wavelength λₜ₂ associate with the distance w₂ from the center line 430.

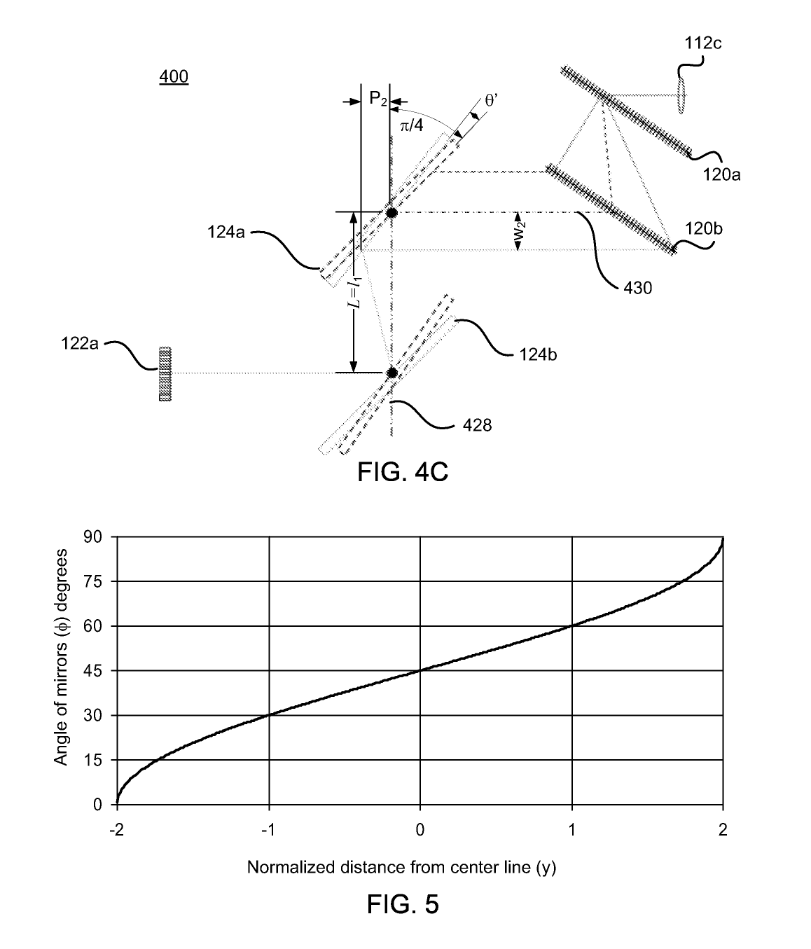

Equations (5) and (11) may be combined into a equation (13) under a unified set of variables listed in equation (12). Equation (13) has been plotted in FIG. 5.

$$φ = \frac{π}{4} + θ = \frac{π}{4} + {θ}^{′} y = \frac{{w}_{1}}{L} = - \frac{{w}_{2}}{L} \qquad ( 12 )$$

The angle φ is defined relative to the first center vertical line 428. The distance y is a normalized distance from the optical center line 430.

$$φ = \{ \begin{matrix}\frac{π}{4} + {tan}^{- 1} ( \frac{2}{y} - \sqrt{\frac{4}{{y}^{2}} - 1} ) & y > 0 \\ \frac{π}{4} & y = 0 \\ \frac{π}{4} + {tan}^{- 1} ( \frac{2}{y} + \sqrt{\frac{4}{{y}^{2}} - 1} ) & y < 0\end{matrix} \qquad ( 13 )$$

Equation (13) has a real solution when y is between 2 and −2.

As the distance between center points L of the two mirrors 124a-b increases, the necessary rotation angle become smaller. For example, if L is 500 mm and the total width of dispersed light at the front of the line sensor has to be 370 mm, then the necessary rotation angle θ and θ′ is from +10.24° to −10.24°, or for φ is 35.24° to 55.24°.

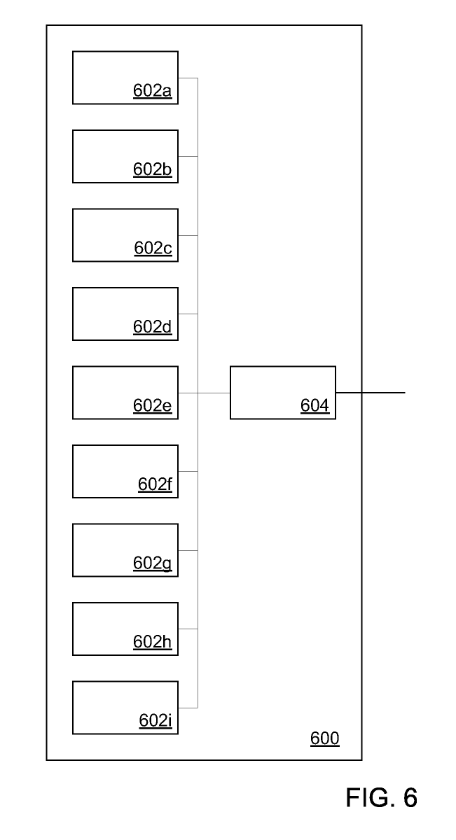

In an alternative embodiment, the light source 102 is replaced with a combined light source 600 which includes multiple narrow light sources 602a-i with different center wavelengths and an optical switch 632 as illustrated in FIG. 6. Total output spectrum of this combined light source 600 is 0.8-1.8 μm. The alternative embodiment is identical to the above embodiments except for the light source 102 is replaced with the combined light source 600.

The spectral width from each of the multiple light sources 602a-i may be about 100 nm as illustrated in FIG. 2B, in which the total number of light sources is 9. The optical switch 632 and the movable mirrors 124a-d are synchronized with the optical switch 632 such that the center wavelength of each narrow light source 602a-i hits center of the line sensors 122a-b.

If the line rate of the line sensor is 140 kHz, the optical switch 632 is driven at 140 kHz and the depth scanning rate is about 16 kHz.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

What is claimed is:

1. A spectral domain optical coherence tomography apparatus for measuring a sample comprising:
receiving a broadband light source, that supplies broadband light to the sample and a reference;
a wavelength selective switch that receives mixed light that is a combination of the broadband light that is reflected off the sample and the reference; and
a sensor that includes a plurality of pixels;
wherein the wavelength selective switch guides a first portion of the mixed light that is within a first wavelength and a second wavelength to the sensor during a first period of time; and
wherein the wavelength selective switch guides a second portion of the mixed light that is within a third wavelength and a fourth wavelength to the sensor during a second period of time.

2. The spectral domain optical coherence tomography apparatus of claim 1, wherein the first period of time and the second period of time do not overlap.

3. The spectral domain optical coherence tomography apparatus of claim 1, wherein the first wavelength is less than the second wavelength, the third wavelength is less than the fourth wavelength, the third wavelength is less than the second wavelength.

4. The spectral domain optical coherence tomography apparatus of claim 1, wherein the wavelength selective switch comprises:
a first diffraction grating with a first grating pitch;
a second diffraction grating with the first grating pitch;
a first movable mirror with a first rotation axis; and
a second movable mirror with a second rotation axis that is parallel to the first rotation axis;
wherein the first diffraction grating is arranged parallel to the second diffraction grating;
wherein the first movable mirror is adjusted to a first angle relative to a first line connecting the first rotation axis and the second rotation axis;
wherein the second movable mirror is adjusted to the first angle relative to the first line, such that wavelength selective switch guides the first portion of the mixed light to the sensor during the first period of time; and
wherein the first and second movable mirrors are adjusted to a second angle relative to the first line, such that wavelength selective switch guides the second portion of the mixed light to the sensor during the second period of time.

5. The spectral domain optical coherence tomography apparatus of claim 1, further comprising the broadband light source.

6. The spectral domain optical coherence tomography apparatus of claim 1, wherein the wavelength selective switch comprises:
a first dispersive optical component which spatially disperse light;
a second dispersive optical component which spatially disperse light;
a first movable mirror with a first rotation axis; and
a second movable mirror with a second rotation axis that is parallel to the first rotation axis;
wherein the first dispersive optical component is arranged relative to the second dispersive optical component such that different wavelengths of the mixed light are spatially dispersed and substantially collinear;
wherein the first movable mirror is adjusted to a first angle relative to a first line connecting the first rotation axis and the second rotation axis;
wherein the second movable mirror is adjusted to the first angle relative to the first line, such that wavelength selective switch guides the first portion of the mixed light to the sensor during the first period of time; and
wherein the first and second movable mirrors are adjusted to a second angle relative to the first line, such that wavelength selective switch guides the second portion of the mixed light to the sensor during the second period of time.

7. A spectral domain optical coherence tomography apparatus for measuring a sample comprising:
receiving a broadband light source, that supplies broadband light to the sample and a reference;
an optical coupler that receives broadband light reflected off the sample and broadband optical light reflected off the references and produced a first mixed light and a second mixed light;
a first wavelength selective switch that receives the first mixed light;
a first sensor that includes a plurality of pixels;
a second wavelength selective switch that receives second mixed light; and
a second sensor that includes a plurality of pixels;
wherein the first wavelength selective switch guides a first portion of the first mixed light that is within a first wavelength and a second wavelength to the first sensor during a first period of time;
wherein the first wavelength selective switch guides a second portion of the first mixed light that is within a third wavelength and a fourth wavelength to the first sensor during a second period of time;
wherein the second wavelength selective switch guides the first portion of the second mixed light that is within the first wavelength and the second wavelength to the second sensor during the first period of time; and
wherein the second wavelength selective switch guides the second portion of the second mixed light that is within the third wavelength and the fourth wavelength to the second sensor during the second period of time.
